(19) United States
(12) Patent Application Publication
(10) Pub. No.: US 2009/0010018 A1
(43) Pub. Date: Jan. 8, 2009

(54) Fiberoptic Cable Assembly

(75) Inventors: Walter Orozco, Jacksonville, FL (US); Eric A. VanDenhende, Jacksonville, FL (US); Christopher K. Black, St. Augustine, FL (US); David C. Mutch, Jacksonville, FL (US)

Correspondence Address: HOWSON AND HOWSON, SUITE 210, 501 OFFICE CENTER DRIVE, FT WASHINGTON, PA, 19034, US

(73) Assignee: SUNOPTIC TECHNOLOGIES LLC, Jacksonville, FL (US)

(21) Appl. No.: 11/772,522

(22) Filed: Jul. 2, 2007

(51) Int. Cl. F21V 8/00; G02B 6/36

(52) U.S. Cl. 362/554; 385/77

(57) ABSTRACT

A fiberoptic cable assembly includes a cable provided as a continuous length of a bundle of optic fibers enclosed within a flexible sheathing and a rigid or semi-rigid protective pistol-grip handle formed about at least a portion of one of the ends of the bundle of optic fibers. The handle includes a grip section, an elongate extension extending from the grip section, and an end fitting connected to an end tip on the extension. The extension extends from the grip section at an angle in a manner forming an elbow therebetween and providing a pistol grip configuration. Preferably, the elongate extension is of a length multiple times greater than its diameter or width.

### BACKGROUND OF THE INVENTION

The present invention relates to a fiberoptic cable having an end releasably connectable to an illuminator, or light source, for the purpose of introducing a high intensity light beam into the cable, and more particularly, the present invention relates to a fiberoptic cable assembly, an end configuration for the assembly, and a cable/illuminator combination particularly adapted for medical applications, such as endoscopic and laparoscopic surgeries or illumination of headlamps worn by surgeons.

Fiberoptic illuminators and like light sources include a lamp within a housing and a jack or port providing a fiberoptic cable interface that permits an end fitment of a fiberoptic bundle or cable to be connected to the housing. The lamp supplies a light beam into the end of the fiberoptic cable, and the cable transmits the light to an endoscope, headlamp, or like medical/surgical device tethered to the illuminator via the cable.

Examples of fiberoptic illuminators and light sources in general are provided by U.S. Pat. No. 5,617,302 issued to Kloots; U.S. Pat. No. 5,295,052 issued to Chin et al.; U.S. Pat. No. 5,243,500 issued to Stephenson et al.; U.S. Pat. No. 5,961,203 issued to Schuda; and U.S. Pat. No. 5,329,436 issued to Shiu, and by U.S. Patent Application Publication No. 2001/0051763 A1 of Kurosawa et al. Some illuminators, such as that disclosed by the '302 Kloots patent, include a turret which defines the port for the end fitting of the fiberoptic cable.

An example of a typical fiberoptic cable assembly is disclosed by U.S. Pat. No. 4,653,848 issued to Kloots and U.S. Pat. No. 4,697,870 issued to Richards. FIG. 1 marked with the legend “Prior Art” illustrates such a fiberoptic cable assembly 10. The typical assembly 10 includes a cable 12 and connectors, boots, or plugs 14 and 16 at opposite ends thereof. The cable comprises a continuous length of a bundle of fibers or filaments encased within a flexible sheath 18. Each connector, 14 and 16, includes an end fitting, 20 and 22, that is receivable within a socket of an illuminator or an endoscope, headlamp, or like medical/surgical device tethered to the illuminator. Stress-relieving sleeves, 24 and 26, extend over portions of the cable 12 and connectors, 14 and 16, for the purpose of relieving stress at the cable-to-connector junctures.

A problem with the above referenced assembly 10 is that when the cable 12 is connected to a port of an illuminator, the cable extends horizontally from the vertically-oriented front face of the illuminator. In this position, gravity acts on the cable to bend it downwardly thereby subjecting the fibers to stress and strain. Stress relieving sleeves, 24 and 26, or the like can at least partially aid in reducing the wear and breakage of the fibers or filaments within the bundle. However, this location of the cable also presents an inviting place to grasp the end of the cable when removing the cable from the illuminator. In addition, turrets and like structures block access to the ends of the cables thereby requiring the cable itself to be grasped for purposes of removing a cable from an illuminator. Grasping the cable at these locations and exerting sufficient force thereon to remove the cable from the illuminator further increases wear on the cable and essentially renders the proximal end of the cable (ie., the end that connects to the illuminator) the weakest part of the cable that is most likely to break and require cable replacement.

Examples of other optical cable assemblies are provided by U.S. Pat. No. 4,652,082 issued to Warner; U.S. Pat. No. 5,710,851 issued to Walter et al.; U.S. Pat. No. 5,073,044 issued to Egner et al.; U.S. Pat. No. 5,503,369 issued to Frost et al.; U.S. Pat. No. 6,554,489 B2 issued to Kent et al.; U.S. Pat. No. 6,629,783 B2 issued to Ngo; U.S. Pat. No. 6,485,194 B1 issued to Shirakawa; and U.S. Pat. No. 6,960,030 B2 issued to Seo et al. and by U.S. Patent Application Publication Nos. 2002/0012504 A1 of Gillham et al. and 2002/0168151 A1 of Murayama et al. Most of these references relate to communication fiber cables. See U.S. Pat. No. 5,785,645 issued to Scheller and U.S. Pat. No. 6,357,932 B1 issued to Auld for examples of cables connected to light sources used in medical applications.

Although the above referenced cable assemblies may be satisfactory for their intended purposes, there is a need for a fiberoptic cable having an end configuration that eliminates the weak point discussed above with respect to the proximal end of the cable. The end configuration should structurally protect the fibers, orient the fibers in a downward direction to lessen strain on the fibers, and provide a logical and easily accessible surface for gripping the end of the cable, for instance, when removing the cable from a light source or like equipment. Preferably, the end configuration of the fiberoptic cable should also efficiently handle heat management issues and should enhance ergonomic and aesthetic qualities of the cable.

### BRIEF SUMMARY OF THE INVENTION

According to a first aspect of the present invention, a fiberoptic cable assembly is provided. The assembly includes a cable provided as a continuous length of a bundle of optic fibers enclosed within a flexible sheathing and a rigid or semi-rigid protective pistol-grip handle formed about at least a portion of one of the ends of the bundle of optic fibers. Preferably, the handle includes a grip section, an elongate extension extending from the grip section, and an end fitting connected to an end tip on the extension. The extension extends from the grip section at an angle in a maimer forming an elbow therebetween and providing a pistol grip configuration. Preferably, the elongate extension is relatively narrow compared to its length such that its length is multiple times greater than its diameter or width.

According to another aspect of the present invention, a fiberoptic cable and illuminator assembly is provided and includes the fiberoptic cable discussed above. The end fitting at a proximal end of the cable is releasably connectable to the illuminator at the port of the illuminator such that light is directed into the bundle of optic fibers.

According to yet another aspect of the present invention, a cable assembly includes an elongate, continuous length of material for transferring electrical or optical signals between opposite ends and a flexible sheathing enclosing the material between the opposite ends. The assembly further includes a rigid or semi-rigid protective pistol-grip handle formed about at least a portion of one of the ends of the material. As an example, the assembly can be for a fiberoptic cable or a cable used with electro-cautery apparatus.

### BRIEF DESCRIPTION OF THE DRAWINGS

The features and advantages of the present invention should become apparent from the following description when taken in conjunction with the accompanying drawings, in which:

FIG. 1 is a plan view of a fiberoptic cable assembly according to the prior art;

FIG. 2 is a perspective view of a proximal end portion of a fiberoptic cable assembly according to the present invention;

FIG. 3 is a perspective view of the proximal end portion of the fiberoptic cable of FIG. 2 releasably connected to an illuminator;

FIG. 4 is a elevational view of the cable and illuminator of FIG. 3; and

FIG. 5 is a cross-sectional view of the proximal end portion of the fiberoptic cable of FIG. 2.

### DETAILED DESCRIPTION OF THE INVENTION

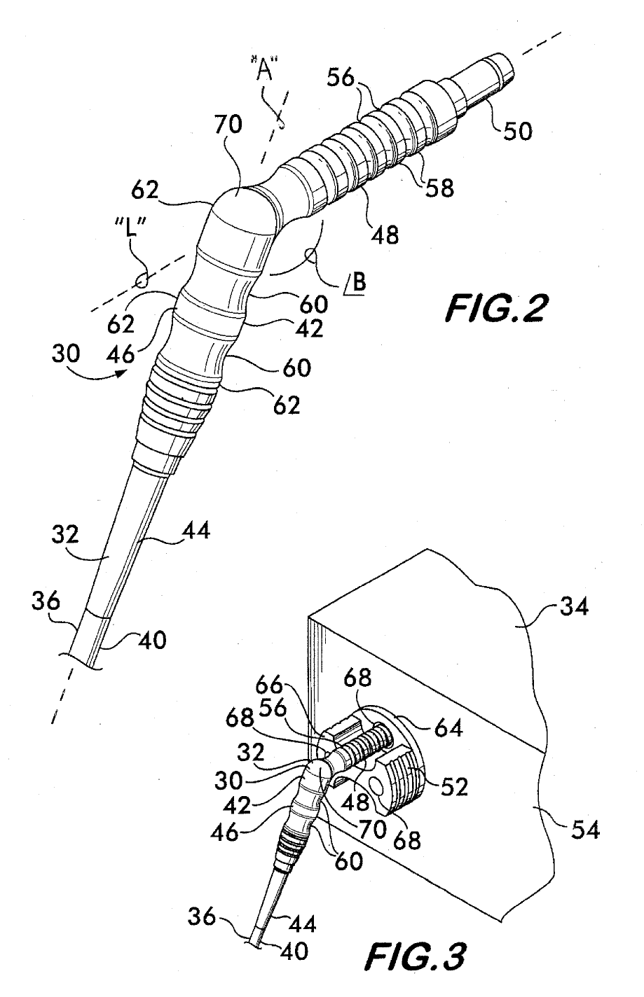

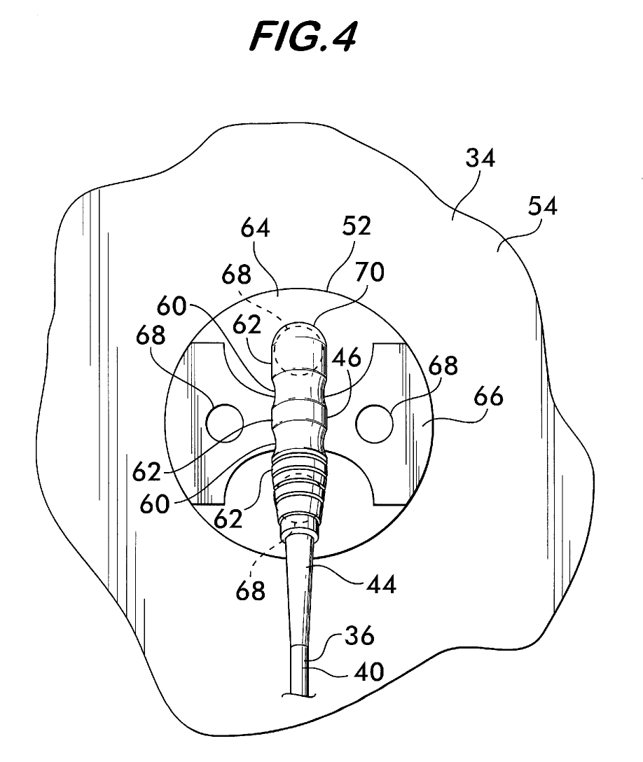

FIG. 2 illustrates a proximal end 30 of a fiberoptic cable assembly 32 according to the present invention. In use, the proximal end 30 is typically connected to an illuminator 34 or like device. See FIGS. 3 and 4. Merely as an example, the illuminator 34 can be that disclosed by co-pending U.S. patent application Ser. No. 11/626,101 which is assigned to the assignee of the present application and which is incorporated herein by reference. Alternatively, the illuminator can be any type or style of lightsource including lightsources with and without turrets and including single port lightsources.

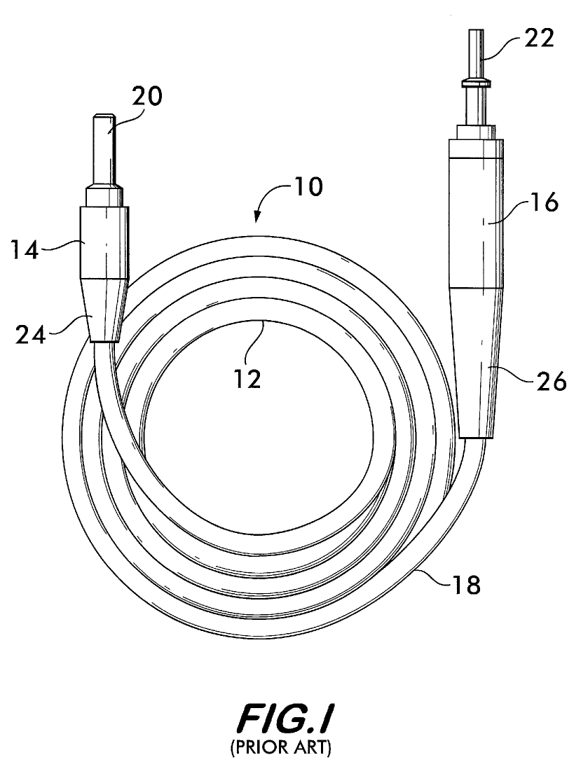

The fiberoptic cable assembly 32 includes a cable 36 provided as a continuous length of a bundle of separate filaments and/or fibers 38, such as glass fibers, encased within a flexible sheathing 40. For example, cable 36 can be similar to cable 12 illustrated in FIG. 1.

The proximal end 30 of the assembly 32 includes a rigid or semi-rigid end section 42 that interconnects to the flexible cable 36 via a stress/strain relieving sleeve 44. See FIG. 2. The end section 42 is hereinafter referred to as a pistol-style handle 42; however, it can also be referred to as a connector, boot, termination, plug, fitting, or end structure.

The handle 42 includes a grip section, or leg, 46 extending from the stress/strain relieving sleeve 44 and an extension 48 extending from the grip section 46 to an end fitting 50 that is of a shape receivable within a port of an illuminator. The extension 48 and grip section 46 of the handle 42 interconnect forming an elbow 70 therebetween and thereby provide the handle 42 with a “pistol” configuration.

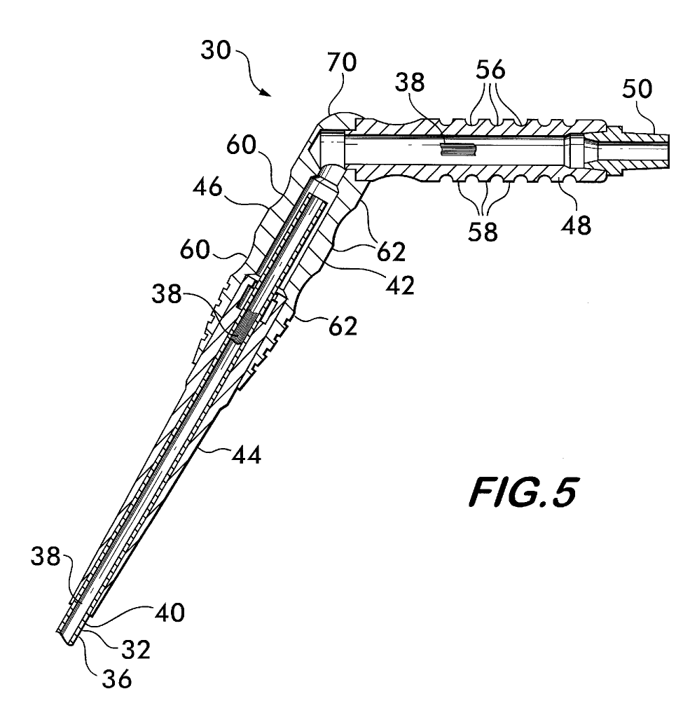

The illustrated embodiment of the extension 48 is shown as a rigid or semi-rigid, relatively-elongate, tubular member having a substantially circular transverse cross-section. Of course, other transverse cross-sectional shapes can be utilized (ie., square, rectangular, oval, etc.). The extension 48 can be provided as a single hollow piece made of plastic, metal or a composite material. See FIG. 5 as an example. Alternatively, the extension 48 can be assembled from an inner hollow tube (not shown) and an outer covering (not shown) made of the same or different materials. The end fitting 50 is mounted to the extension 48 via the use of complementary machine threads or like fastening mechanism. Preferably, the bundle of fibers 38 of the cable extends continuously within and through the hollow extension 48 so that its end face can be positioned to receive light from the illuminator via end fitting 50. Alternatively, a light conducting medium can be mounted within the extension 48 to transfer light to the end face of the bundle of fibers.

As discussed above, the assembly fiber optic cable assembly 32 can be used with any type of lightsource; however, the extension 48 of handle 42 provides a particular advantage when used in combination with an illuminator 34 having a turret 52 or like structure. By way merely of example, a typical turret 52 has a base 64 mounted adjacent to a front wall 54 of a housing of the illuminator 34 and a body 66 extending forward from the base 64 and front wall 54. The base 64 of the turret 52 can be rotatably mounted to the front wall 54 to enable any one of several different ports 68 of the turret 52 to be aligned with the light projected through the front wall 54 of the illuminator 34. Typically, the different ports 68 are of various sizes enabling different sized and shaped end fittings of different cable manufacturers to be connected to the illuminator 34. As an example, a pair of ports extends solely through the base 64 at a location laterally spaced from the body 66, and a pair of ports extends directly through the body 66 and base 64 of the turret 52.

Preferably, the extension 48 extends in a substantially straight line path along its longitudinal axis “L” and is of a length that is greater than the distance to which the turret 52 extends from a front face 54 of the illuminator 34. This enables the extension 48 to locate the grip section 46 of the handle 42 beyond the turret 52 to prevent any interference between the turret 52 and handle 42. In addition, preferably the length of the extension is multiple times greater than its diameter or width so that the end fitting can be received in the port in the base 64 of the turret 52 without the extension 52 contacting or being obstructed by the body 66 of the turret 52.

By way of example, and not be way of limitation, the extension 48 can have a length that is at least about four times greater than its diameter or width. For example, see the relative sizes of the length and diameter of extension 48 illustrated in FIGS. 2 and 5. As a further example, the extension can have a length of about 1 to 4 inches. For instance, an extension 48 having a diameter of about ⅝ inch may have a length of about 2.5 inches. Of course, the dimensions can be altered as desired provided that the cable can be connected to the illuminator 34 without interference between the extension 48 and the turret 52 and provided sufficient space is provided to permit a person's fingers to freely extend around the grip section 46 without interference from the front face 54 or turret 52 of the illuminator 34.

The outer peripheral surface of the extension 48 can be provided with a series of circumferential grooves 56 and lands, or fins, 58. This shape increases the surface area of the extension 48 and promotes dissipation of heat transferred to the proximal end 30 from the illuminator 34. For this reason, the extension 48 can be made of a metallic or heat conducting material.

Similar to the extension 48, the grip section 46 is also relatively elongate and extends along its longitudinal axis “A” which extends at an angle “B” relative to axis “L” of the extension 48. This provides the handle 42 with the so-called “pistol” shape. The grip section 46 is the part of the proximal end 30 that is intended to be gripped by a person when connecting the proximal end 30 to the illuminator 34 or when removing the proximal end 30 from the illuminator. The angle “B” between the grip section 46 and extension 48 can be any angle that enables ergonomic gripping of handle 42. A preferred angle for angle “B” is about 120°; however, this angle can be altered. The grip section 46 can include circumferential grooves 60 and swells 62 to enhance the ergonomics with respect to gripping the handle 42 (ie., provide finger receiving recesses).

The grip section 46 can be made of plastic, metal, synthetic rubber, or a composite material. As an example, the grip section 46 can be molded of ABS or silicone rubber and can be molded integral with the extension 48, if desired. Alternatively, the extension 48 can be connected to the grip section 46 via a threaded connection, an adhesive, friction fit, snap fit, welded or other connection. For an example, see FIG. 5. The sheathing 40 or stress/strain relieving sleeve 44 of the cable 36 can be adhesively secured, snap fit, or welded to the grip section 46 (see FIG. 5), and the bundle of fibers 38 can extend through the hollow grip section 46 into the extension 48 to a position adjacent the end fitting 50.

In use, the grip section 46 is gripped by hand and used to manipulate the end fitting 50 into the port of the illuminator 34. If the illuminator 34 includes a turret 52, the extension 48 is sufficiently narrow and long to locate the grip section 46 beyond the free end of the turret 52 to enable easy access to the grip section 46 without having to contact the turret 52, which may be hot to the touch after extended use of the illuminator depending on the type/style of illuminator. When the cable is to be removed from the illuminator 34, the grip section 46 is grasped and a force is exerted to remove the cable from the illuminator 34.

The grip section 46 and extension 48 of the handle 42 are sufficiently rigid to protect the bundle of fibers of the cable 36 extending therein and to orient the cable 36 in a downward direction as shown in FIG. 3 to lessen strain on the bundle of fibers. Further, the grip section 46 and extension 48 prevent wear and tear of the bundle of fibers that would otherwise be experienced when forces are exerted thereon to connect or disconnect the cable relative to the illuminator. Thus, the pistol-style handle 42 lengthens the useful life of the cable assembly 32 and eliminates the otherwise weak point in the proximal end. The opposite end (not shown) of cable 36 can be connectable to an endoscope, headlamp, or other device.

While the present invention has been described in connection with a cable having a bundle of fibers, the handle structure of the present invention can be extended to other applications. For example, an electrical cable, such as used with electro-cautery apparatus can also be provided with the handle configuration of the present invention.

While a preferred cable, handle for the cable, and cable/illuminator combinations have been described in detail, various modifications, alternations, and changes may be made without departing from the spirit and scope of the cable, handle and combination according to the present invention as defined in the appended claims.

1. A fiberoptic cable assembly, comprising:
a cable including a continuous length of a bundle of optic fibers having opposite ends and a flexible sheathing enclosing said bundle of optic fibers between said opposite ends; and
a rigid or semi-rigid protective pistol-grip handle formed about at least a portion of one of said ends of said bundle of optic fibers.

2. A fiberoptic cable assembly according to claim 1, wherein said handle includes a grip section, an elongate extension extending from said grip section, and an end fitting connected to a free end tip of said extension.

3. A fiberoptic cable assembly according to claim 2, wherein said extension extends from said grip section at an angle in a manner forming an elbow therebetween.

4. A fiberoptic cable assembly according to claim 3, wherein said elongate extension is a generally tubular member, and wherein said length of said elongate extension is at least four times said diameter of said elongate extension.

5. A fiberoptic cable assembly according to claim 4, wherein said grip section has a longitudinal axis and said extension has a longitudinal axis, and wherein said angle between said longitudinal axis of said grip section and said longitudinal axis of said extension is about 120°.

6. A fiberoptic cable assembly according to claim 4, wherein said elongate extension is made of metal and has a series of circumferential grooves for enhancing heat dissipation.

7. A fiberoptic cable assembly according to claim 4, wherein said grip section has a series of circumferential grooves and swells providing ergonomic gripping.

8. A fiberoptic cable assembly according to claim 7, wherein said grip section is made of plastic, metal, synthetic rubber, or a composite material.

9. A fiberoptic cable assembly according to claim 4, wherein said handle is made of plastic, metal, synthetic rubber, or a composite material.

10. A fiberoptic cable assembly according to claim 4, wherein said handle interconnects to said cable via a stress relieving sleeve.

11. A fiberoptic cable and illuminator assembly, comprising
an illuminator having a wall with a port; and
a separate fiberoptic cable including a continuous length of a bundle of optic fibers having distal and proximal ends, a flexible sheathing enclosing said bundle of optic fibers between said distal and proximal ends, and a rigid or semi-rigid protective pistol-grip handle formed about at least a portion of said proximal end of said bundle of optic fibers;
said proximal end of said cable having an end fitting releasably connectable to said illuminator at said port of said illuminator so that light is directed into said bundle of optic fibers.

12. A fiberoptic cable and illuminator assembly according to claim 11, wherein said handle includes a grip section and an elongate extension extending from said grip section, and wherein said end fitting of said cable extends from a free end tip of said extension.

13. A fiberoptic cable and illuminator assembly according to claim 12, wherein said extension extends from said grip section at an angle in a manner forming an elbow therebetween.

14. A fiberoptic cable and illuminator assembly according to claim 13, wherein said illuminator includes a turret.

15. A fiberoptic cable and illuminator assembly according to claim 14, wherein said turret includes a base plate and a body portion, said base plate is positioned adjacent said wall of said illuminator, and said body portion extends forward a predetermined distance from said base plate.

16. A fiberoptic cable and illuminator assembly according to claim 15, wherein said elongate extension is of a length that is equal to or greater than said predetermined distance defined by said body portion of said turret.

17. A fiberoptic cable and illuminator assembly according to claim 13, wherein said elongate extension is a generally tubular member, and wherein said length of said elongate extension is at least four times said diameter.

18. A fiberoptic cable and illuminator assembly according to claim 13, wherein said grip section has a longitudinal axis and said extension has a longitudinal axis, and wherein said angle between said longitudinal axis of said grip section and said longitudinal axis of said extension is about 120°.

19. A fiberoptic cable and illuminator assembly according to claim 18, wherein said elongate extension is made of metal and has a series of circumferential grooves for enhancing heat dissipation.

20. A fiberoptic cable and illuminator assembly according to claim 19, wherein said grip section has a series of circumferential grooves and swells providing ergonomic gripping.

21. A fiberoptic cable and illuminator assembly according to claim 20, wherein said grip section is made of plastic, metal, synthetic rubber, or a composite material.

22. A fiberoptic cable assembly according to claim 21, wherein said handle interconnects to said cable via a stress relieving sleeve.

23. A fiberoptic cable and illuminator assembly according to claim 18, wherein said handle is made of plastic, metal, synthetic rubber, or a composite material.

24. A cable assembly, comprising:
an elongate, continuous length of material for transferring electrical or optical signals between opposite ends and a flexible sheathing enclosing said material between said opposite ends; and
a rigid or semi-rigid protective pistol-grip handle formed about at least a portion of one of said ends of said material.
